(19) United States
(12) Patent Application Publication
(10) Pub. No.: US 2018/0153168 A1
(43) Pub. Date: Jun. 7, 2018

(54) A PRIMER FOR PESTICIDES

(71) Applicant: PANGAEA AGROCHEMICALS LIMITED, Norwich, Norfolk (GB)

(72) Inventors: Michael John Gifford, Norwich, Norfolk (GB); Nicholas Anthony Gooch, Norwich, Norfolk (GB)

(21) Appl. No.: 15/578,637

(22) PCT Filed: May 31, 2016
(86) PCT No.: PCT/GB2016/051585

§ 371 Date: Nov. 30, 2017

(30) Foreign Application Priority Data
Jun. 3, 2015 (GB) 1509615.9

(51) Int. Cl. A01N 43/30; A01N 25/34; A01N 43/40

(52) U.S. Cl. CPC A01N 43/30; A01N 43/40; A01N 25/34

(57) ABSTRACT

An emulsion of piperonyl butoxide is employed as a primer for pesticides (especially herbicides). Three key factors can be deployed in various combinations to increase the efficacy of piperonyl butoxide, namely: (1) particle size; (2) time delay; and (3) dose rate.

### FIELD OF THE INVENTION

The present application relates to a method for treating a plant crop and a kit of components for carrying out such a method. In particular, it relates to a chemical primer for applying to a crop before applying a pesticide in order to improve the pesticide's efficacy.

### BACKGROUND OF THE INVENTION

A wide range of adjuvant chemicals are known that are routinely added to spray tanks together with active herbicides. These adjuvants act to aid or modify the action of a herbicide or the physical characteristics of the mixture. One class of adjuvants are synergists which can be simply defined as chemical additives to a mixture containing herbicides that increase the efficacy of the mixture beyond the efficacy of the component parts.

Piperonyl butoxide is a synergist that is known to inhibit the activity of the P450 cytochrome enzyme group. This group of enzymes is responsible for the detoxification of many living organisms including plants. When applied to plants in the absence of any active ingredients the toxicity of piperonyl butoxide alone is not detectable and the plants show no ill effects of the treatment.

In experiments the synergistic effects of using piperonyl butoxide in a tank mix with herbicides have been either undetectable or extremely limited. They have been insufficient to warrant the additional expense of including piperonyl butoxide in a field based herbicide treatment.

EP 1 499 183 B1 (Rothamsted Research Limited) discloses a method for preventing or reducing resistance of a pesticide (such as an insecticide) to a substrate pest comprising administering to the substrate or the pest (a) a rapid release formulation of an activity inhibitor (such as piperonyl butoxide) and substantially simultaneously (b) a pesticide encapsulated in a degradable capsule.

Other background art is disclosed in GB 1556372 (Shell International Research); US 2013/288897 (Babcock); and CN 102885091 (Wang).

### SUMMARY OF THE INVENTION

The present applicant has discovered three key factors which can be deployed in various combinations to increase the inhibitor efficacy of piperonyl butoxide: (1) particle size; (2) time delay; and (3) dose rate.

Particle Size

In accordance with a first aspect of the present invention, there is provided a kit including a first component which is an emulsion of piperonyl butoxide in which the majority of piperonyl butoxide is in the form of particles having a particle size of 1 micrometre or less, and a second component which has herbicidal properties, for example glyphosate, clodinafop propargyl, clethodim, propaquizafop, cycloxadim, diclofop-methyl or fenoxaprop.

Experiments have shown that surprisingly an emulsion concentrate in which the bulk of the piperonyl butoxide is in the form of particles with a size of 1 μm or less, preferably 500 nm or less, has a good synergistic effect. Most preferably, the emulsion has a mono-modal particle size distribution in which 75% of the particles are from 80 nm to 400 nm in size.

Although piperonyl butoxide is known as an adjuvant for use with pesticides, there is no suggestion in the prior art that it can be used as an adjuvant for herbicides nor that particle size is a key factor in increasing its adjuvant efficacy.

Time Delay

In a second aspect of the present invention, there is provided a method for treating a plant crop comprising applying to the plant a first component as defined above and applying to the plant a second component as defined above. Preferably, the first component is applied first and the second component applied second after a time delay.

It has surprisingly been discovered that in order to get a high degree of synergism between piperonyl butoxide and a herbicide the piperonyl butoxide must be applied ahead of the herbicide.

It has also been discovered that a time delay increases the inhibitor efficacy of piperonyl butoxide in relation to any pesticide. By “pesticide” is meant any herbicide, insecticide, insect growth regulator, nematicide, termiticide, molluscicide, piscicide, avicide, rodenticide, predacide, bactericide, insect repellent, animal repellent, antimicrobial, fungicide, disinfectant (antimicrobial), or sanitizer.

Thus, in a third aspect of the present invention, there is provided a method for treating a plant crop comprising applying to the plant a first component of the kit as defined above and applying to the plant a second component which is a pesticide, wherein the first component is applied first and the second component applied second after a time delay.

Preferably, the time delay is from 1 to 24 hours, preferably from 2 to 8 hours. However, the time delay required varies with temperature and dose rate. As temperature increases the optimum time delay required decreases from 8 hours at 11° C. to 4 hours at 15° C. to 2.5 hours at 25° C. (these time delays assume an optimised dose rate).

As dose rate is decreased the optimum time delay also decreases from 5 hours at 825 grams per hectare to 2.5 hours at 412.5 grams per hectare (both points at 25° C.).

Dose Rate

Further experiments relating to the dose rates that are required for effectiveness have shown that as expected for any plant protection product there is a minimum effective dose rate. Much more surprisingly it has been shown in experiments that application rates of piperonyl butoxide at 825 g per hectare result in considerably worse efficacy than when applied at 412.5 g per hectare. This effect is extremely unusual in any pesticide or plant protection product.

In accordance with a fourth aspect of the invention, therefore, there is provided a method for treating a plant crop comprising applying to the plant a first component of the kit as defined above and applying to the plant a second component which is a pesticide, wherein the first component is applied at a concentration of piperonyl butoxide of from 100 to 500 grams of piperonyl butoxide per hectare of crop, preferably from 160 to 320 grams of piperonyl butoxide per hectare of crop.

The first and second components are preferably applied in the methods defined above by spraying.

Utilising the prior art described in patent EP 1,499183 B2 it is possible to get the time delay required through the microencapsulation of the clodinafop propargyl. Providing the conditions around droplet size of the surrounding piperonyl butoxide emulsion and the dose rates for the piperonyl butoxide are within the limits previously defined, this will allow a single-spray solution to be developed.

The use of very fine droplet emulsions of piperonyl butoxide may provide additional efficacy when applying the same approach of either time split applications or encapsulated time-delayed applications (as described in EP 1,499183 B2) of insecticides and fungicides. In particular, with insecticides, it has been found that the optimum delay for application is highly variable and ranges between approximately 1 hour for pollen beetle and 8 hours for white fly. If a finer droplet size is able to increase the rate of uptake of the PBO by an insect it may be possible to reduce the longer time delays and hence make the encapsulation methods easier to apply and the product more effective in climates where meteorological conditions may change on an hourly basis.

A number of preferred embodiments of the present invention will now be described with reference to the accompanying drawings, in which:

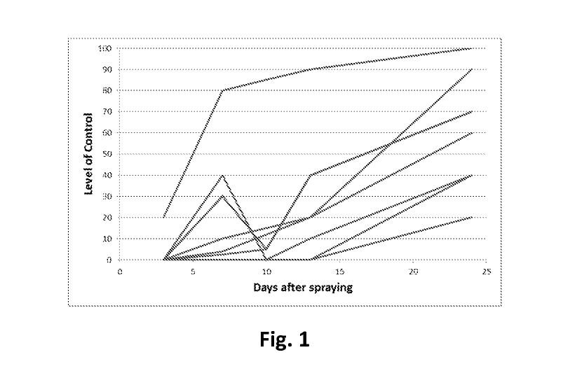

FIG. 1 is a graph showing how in 8 replicated trials the level of herbicidal control varies a number of days after spraying for Italian ryegrass treated with glyphosate;

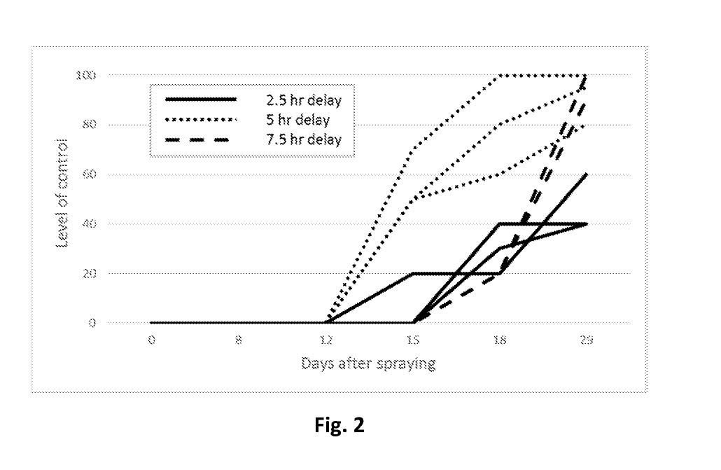

FIG. 2 is a graph showing the effect on efficacy of a time delay between the application of piperonyl butoxide and glyphosate;

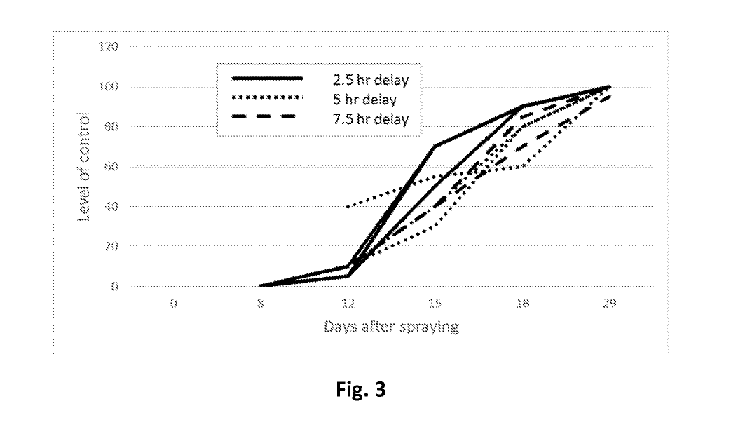

FIG. 3 is a similar graph as for FIG. 2 but with a lower dose rate of piperonyl butoxide;

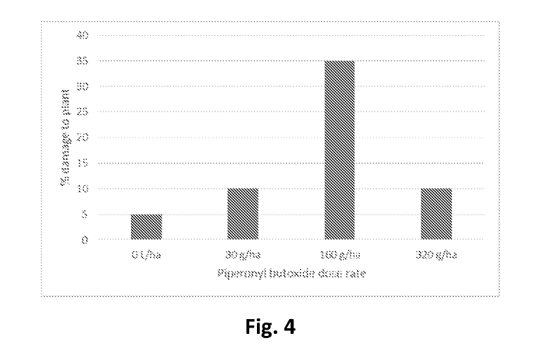

FIG. 4 is a graph showing the effect of dose rate of piperonyl butoxide on efficacy of the herbicidal effect of clodinafop propargyl on blackgrass;

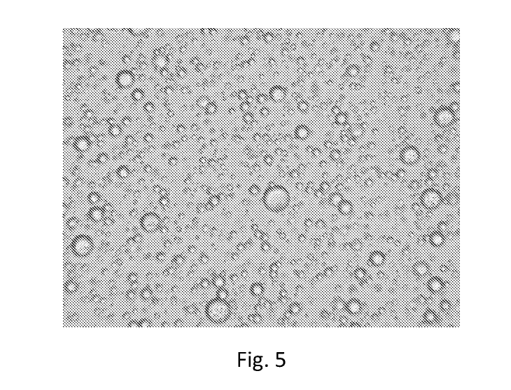

FIG. 5 is an optical micrograph of conventional piperonyl butoxide emulsion;

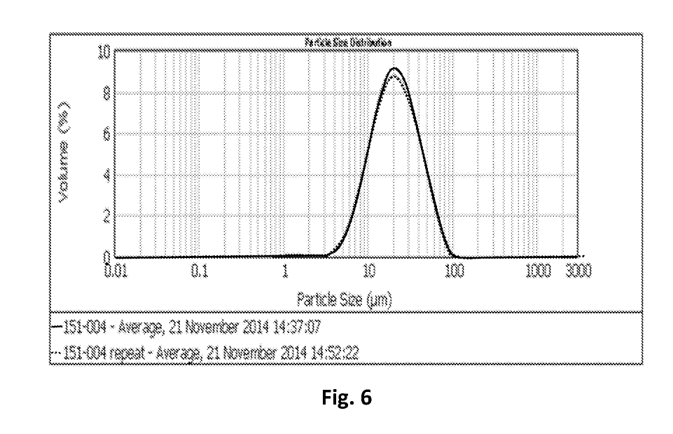

FIG. 6 shows the particle size distribution for a conventional piperonyl butoxide emulsion showing peak at 20 μm;

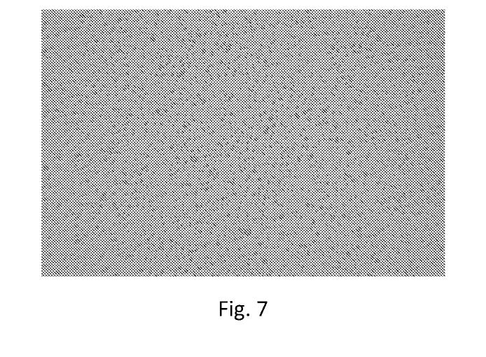

FIG. 7 is an optical micrograph of a piperonyl butoxide micro-emulsion for use in the present invention;

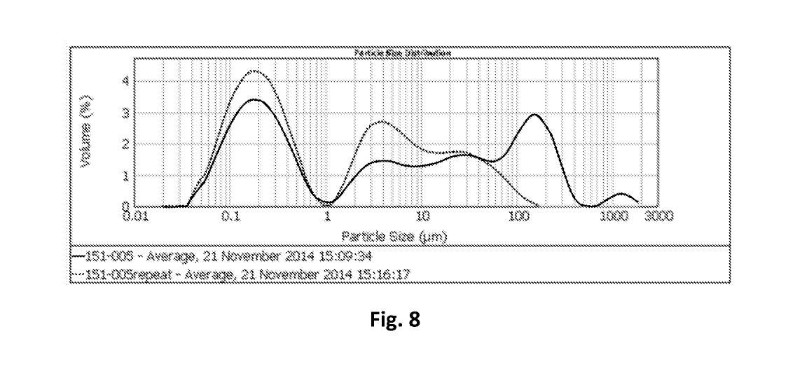

FIG. 8 shows the particle size distribution for the micro-emulsion of FIG. 7; and

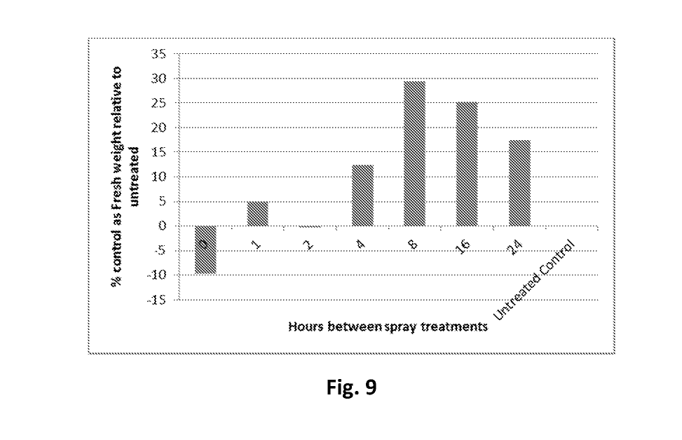

FIG. 9 shows the effect on efficacy of a time delay between the application of piperonyl butoxide and clodinafop on blackgrass.

### EXAMPLES

Experiments carried out in Western Australia showed considerably improved control of a glyphosate resistant strain of Italian ryegrass. As can be seen in FIG. 1, in 8 replicated trials the level of control achieved without piperonyl butoxide was minimal. FIG. 2 shows that some control is achieved through the pre-treatment of the weed with piperonyl butoxide at 825 grams per hectare. The control achieved in FIG. 3 using 412.5 grams per hectare is significantly better.

FIG. 2 and FIG. 3 show that at the higher temperature of 25° C., good efficacy can be obtained using a delay between the piperonyl butoxide and the active pesticide of between 2.5 and 7.5 hours. Specifically, FIG. 2 shows results from glyphosate resistant Italian ryegrass treated with optimised piperonyl butoxide at 825 g/ha followed at a delay with a treatment of glyphosate at 900 g ai/ha and FIG. 3 shows results from glyphosate resistant Italian ryegrass treated with optimised piperonyl butoxide at 412.5 g/ha followed at a delay with a treatment of glyphosate at 900 g ai/ha.

These results also indicate that the optimum time-delay is lower when the piperonyl butoxide dose is lower. It is clear that for the 412.5 g per hectare dose rate (FIG. 3) the optimum time delay is approximately 2.5 hours whereas for the 825 g per hectare dose rate (FIG. 2) the optimum time delay is around 5 hours.

Further experiments were carried out using clodinafop resistant strains of blackgrass. These showed the same trend of there being an optimum piperonyl butoxide dose rate above which increasing doses lead to reductions in absolute efficacy. The results of these experiments are shown in FIG. 4, which relates to Clodinafop resistant blackgrass treated with optimised piperonyl butoxide at different dose rates followed after a 4 hour delay with a treatment of clodinafop propargyl at 250 g ai/ha.

It has been seen in a number of field trial experiments that where piperonyl butoxide is presented in the form of large irregular droplets (see FIG. 5 and FIG. 6) the efficacy of the material is substantially reduced. Use of a suitable emulsifying agent consisting of a combination of anionic and non-anionic surfactants and appropriate mixing produces a micro-emulsion (see FIG. 7 and FIG. 8). In particular, FIG. 8 is a particle size distribution of an optimised piperonyl butoxide micro-emulsion. The principal peak is below 200 nm. Microscopy showed the other peaks to be due to agglomerations which are easily dispersed with agitation.

Use of such a micro-emulsion has been shown in field trials to be far more effective. The method for creating the micro-emulsion is well established in the literature and the novel element is in establishing its necessity for use as a synergist for herbicidal activity against resistant pest species.

In early autumn trials where the ambient temperature has been of the order of 18° C. the optimum delay has been shown to be between 2-8 hours (preferably 4 hours) with no measurable efficacy remaining at the 24-hour point. In the trial shown in FIG. 9, the peak efficacy takes place significantly later than this with high levels of control being shown with delays of 8-16 hours. Specifically, FIG. 9 shows control of resistant blackgrass strain using optimised piperonyl butoxide at 320 grams per ha followed by clodinafop at 250 g ai/ha. Daytime temperature of 11° C. Night time temperature of 8° C. Optimum delay for efficacy is approximately 8 hours.

1. A kit including:
a first component which is an emulsion of piperonyl butoxide in which the majority of piperonyl butoxide is in the form of particles having a particle size of 1 micrometre or less, and
a second component which has herbicidal properties.

2. A kit as claimed in claim 1, wherein said particle size is 500 manometers or less.

3. A kit as claimed in claim 1, wherein the emulsion has a mono-modal particle size distribution in which 75% of the particles are from 80 nm to 400 nm in size.

4. A kit as claimed in claim 1, wherein the herbicide is glyphosate, clodinafop propargyl, clethodim, propaquizafop, cycloxadim, diclofop-methyl or fenoxaprop.

5. A method for treating a plant crop comprising applying to the plant a first component which is an emulsion of piperonyl butoxide in which the majority of piperonyl butoxide is in the form of particles having a particle size of 1 micrometre or less and applying to the plant a second component which has herbicidal properties.

6. A method as claimed in claim 5, wherein the first component is applied first and the second component applied second after a time delay.

7. A method for treating a plant crop comprising applying to the plant a first component which is an emulsion of piperonyl butoxide in which the majority of piperonyl butoxide is in the form of particles having a particle size of 1 micrometre or less, and applying to the plant a second component which is a pesticide, wherein the first component is applied first and the second component applied second after a time delay.

8. A method as claimed in claim 7, wherein the time delay is from 1 to 24 hours.

9. A method as claimed in claim 8, wherein the time delay is from 2 to 8 hours.

10. A method as claimed in claim 5, wherein the second component is glyphosate, clodinafop propargyl, clethodim, propaquizafop, cycloxadim, diclofop-methyl or fenoxaprop.

11. A method for treating a plant crop comprising applying to the plant the first and second components of the kit of claim 1, wherein the first component is applied at a concentration of piperonyl butoxide of from 100 to 500 grams of piperonyl butoxide per hectare of crop.

12. A method as claimed in claim 5, wherein the first component is applied at a concentration of piperonyl butoxide of from 100 to 500 grams of piperonyl butoxide per hectare of crop.

13. A method as claimed in claim 11, wherein the concentration is from 160 to 320 grams of piperonyl butoxide per hectare of crop.

14. A method as claimed in claim 5, wherein the first and second components are applied by spraying.

15.-19. (canceled)

20. A method as claimed in claim 6, wherein the time delay is from 1 to 24 hours.
